(19) United States
(12) Patent Application Publication
(10) Pub. No.: US 2005/0286787 A1
(43) Pub. Date: Dec. 29, 2005

(54) Information processing apparatus, move history management method, and data structure of image data

(76) Inventors: Yutaka Yagiura, Kanagawa (JP); Sachiko Takeuchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/154,659

(22) Filed: Jun. 17, 2005

(30) Foreign Application Priority Data
Jun. 23, 2004 (JP) 2004-185230
Jun. 14, 2005 (JP) 2005-174361

(51) Int. Cl. G06K 9/46

(52) U.S. Cl. 382/239

(57) ABSTRACT

In an information processing apparatus for managing move history information of image data being stored in an image data storing part, the move history information of the image data stored in the image data storing part from the image data is acquired, and the move history information is provided as data for displaying the move history information.

### BACKGROUND OF THE INVENTION

1. Field of the Invention

The present invention generally relates to information processing apparatuses, move history management methods, and data structures of image data, and more particularly to an information processing apparatus, a move history management method, and a data structure of image data, in which move history information of the image data stored in an image data storing part is managed.

2. Description of the Related Art

Accompanying recent developments of technologies of the Internet, a LAN (Local Area Network), and a like, it becomes possible to easily connect to an information processing apparatus such as a PC (Personal Computer), an MFP (Multi-Function Printer), or a like. It is possible to make the information processing apparatus connected through the network function as a repository storing various types of files.

A file sharing is realized by allowing a user to move or copy files stored in the information processing apparatuses among these information processing apparatuses. For example, the user moves or copies a file stored in one repository to another repository, and also can use the file.

Conventionally, when a file stored in the information processing apparatus is allowed to be moved or copied, it is required to manage a move destination or a copy destination of the file. For example, the Japanese Laid-open Patent Application No. 2001-27960 discloses a document management method in that when a part of a document stored in a first document management apparatus is moved to a second document management apparatus, index information and/or link information are maintained in the first document management apparatus, and only contents are moved.

Moreover, the Japanese Laid-open Patent Application No. 2003-173329 discloses that a terminal conducting a creation and an edit of an electronic document, a directory service managing a storage location of the electronic document, and a service maintaining the electronic document are connected to each other, an URL (Uniform Resource Locator) of the directory service is recorded in the electronic document, and current storage information of the electronic document is informed to the directory service indicated by the URL when the electronic document is operated.

However, in a case in that the move destination or the copy destination of the file are only managed as described in the Japanese Laid-open Patent Application No. 2001-27960 and the Japanese Laid-open Patent Application No. 2003-173329, there is a problem in that it is impossible to correspond to a case in that it attempts to manage a move source or a copy source of the file. Moreover, in a document management system described in the Japanese Laid-open Patent Application No. 2003-173329, the directory service managing the storage location of the electronic document is required to be arranged separately from the terminal and the service storing the electronic document. Disadvantageously, costs are greatly increased.

Some of devices for sending and receiving image data such as a facsimile manage the move source and the copy source of the file by application software. However, since the devices for sending and receiving the image data such as the facsimile manages the move source or the copy source of the file only once, if the file is repeatedly moved, previous move sources or copy sources cannot be recognized.

### SUMMARY OF THE INVENTION

It is a general object of the present invention to provide information processing apparatuses, move history management methods, and data structures of image data, in which the above-mentioned problems are eliminated.

A more specific object of the present invention is to provide an information processing apparatus, a move history management method, and a data structure of image data, in which a move history of image data can be easily managed.

For example, if the move history including a move destination or a copy destination of a file and a move source or a copy source of the file is displayed on screens which can be switched in response to an instruction from a user, it is significantly useful for the user.

The above objects of the present invention are achieved by an information processing apparatus for managing move history information of image data being stored in an image data storing part, said information processing apparatus including: an image data managing part acquiring the move history information of the image data stored in the image data storing part from the image data, and providing the move history information as data for displaying the move history information.

The above objects of the present invention are achieved by an information processing apparatus for managing move history information of image data previously stored in an image data storing part, said information processing apparatus including: an image data managing part acquiring move history information of the image data from link data including the move destination information of the image data and the move history information of the image data, and providing the move history information of the image data as data for displaying the move history information.

The above objects of the present invention are achieved by a move history management method conducted in an information processing apparatus for managing move history information of image data being stored in an image data storing part, said move history management method including the step of: acquiring move history information of the image data being stored in the image data storing part from the image data, and providing the move history information as data for displaying the move history information.

The above objects of the present invention are achieved by a move history management method conducted in an information processing apparatus for managing move history information of image data previously stored in an image data storing part, said move history management method including the step of: acquiring move history information of the image data form link data including the image data and the move history information of the image data, and providing the move history information as data for displaying the move history information.

The above objects of the present invention are achieved by a data structure of image data including bibliography information and page information, wherein move history information of the image data is recorded in the bibliography information, and the move history information is read out from the bibliography information by an information processing apparatus for managing the move history information of the image data being stored in the image storing part, so that the image history information is provided as data for displaying the move history information of the image data.

According to the present invention, since the image data includes the move history information, and the move history information acquired from the image data is provided, it is possible to easily display the move history information of the image data stored in the image data storing part. For example, the user can confirm the move history information of the image data on a screen and can easily manage the move history information of the image data.

### BRIEF DESCRIPTION OF THE DRAWINGS

In the following, embodiments of the present invention will be described with reference to the accompanying drawings.

FIG. 1 is a diagram showing an example of a system configuration realizing a move history management method according to the present invention;

FIG. 2 is a diagram showing an example of a configuration of the MFP according to the present invention;

FIG. 3 is a diagram showing an example of a hardware configuration of the MFP according to the present invention;

FIG. 4 is a diagram showing an example of a data structure of the document file according to the present invention;

FIG. 5 is a diagram showing a data structure of an example of the move history according to the present invention;

FIG. 6 is a diagram showing a data structure of an example of the link document file according to the present invention;

FIG. 7 is a diagram showing a data structure of an example of a page link document file according to the present invention;

FIG. 8 is a diagram showing a sequence example for explaining a move process and a move history display process of the document file according to a first embodiment of the present invention;

FIG. 9 is a diagram showing one image example of the all document list display screen according to the first embodiment of the present invention;

FIG. 10 is a flowchart for explaining an example of an all document list display process according to the first embodiment of the present invention;

FIG. 11 is a flowchart for explaining an example of the document move process according to the first embodiment of the present invention;

FIG. 12 is a diagram showing another image example of the all document display screen according to the first embodiment of the present invention;

FIG. 13 is a diagram showing an image example of a move history according to the first embodiment of the present invention;

FIG. 14 is a diagram showing still another image example of the all document list display screen according to the first embodiment of the present invention;

FIG. 15 is a flowchart for explaining one example of a document move history display process according to the first embodiment of the present invention;

FIG. 16 is a diagram showing a sequence example for explaining a trace process and a like process for the document file which is moved, according to a second embodiment of the present invention;

FIG. 17 is a diagram showing an image example of a moved document list display screen according to the second embodiment of the present invention;

FIG. 18 is a flowchart for explaining one example of a moved document list display process according to the second embodiment of the present invention;

FIG. 19 is a flowchart for explaining one example of a document link process according to the second embodiment of the present invention;

FIG. 20 is a diagram showing a sequence example of a process for operating the document file by a page unit, according to a third embodiment of the present invention; and

FIG. 21 is a diagram showing an image example of the document file operation screen according to the third embodiment of the present invention.

### DESCRIPTION OF THE PREFERRED EMBODIMENTS

In the following, embodiments of the present invention will be described with reference to the accompanying drawings.

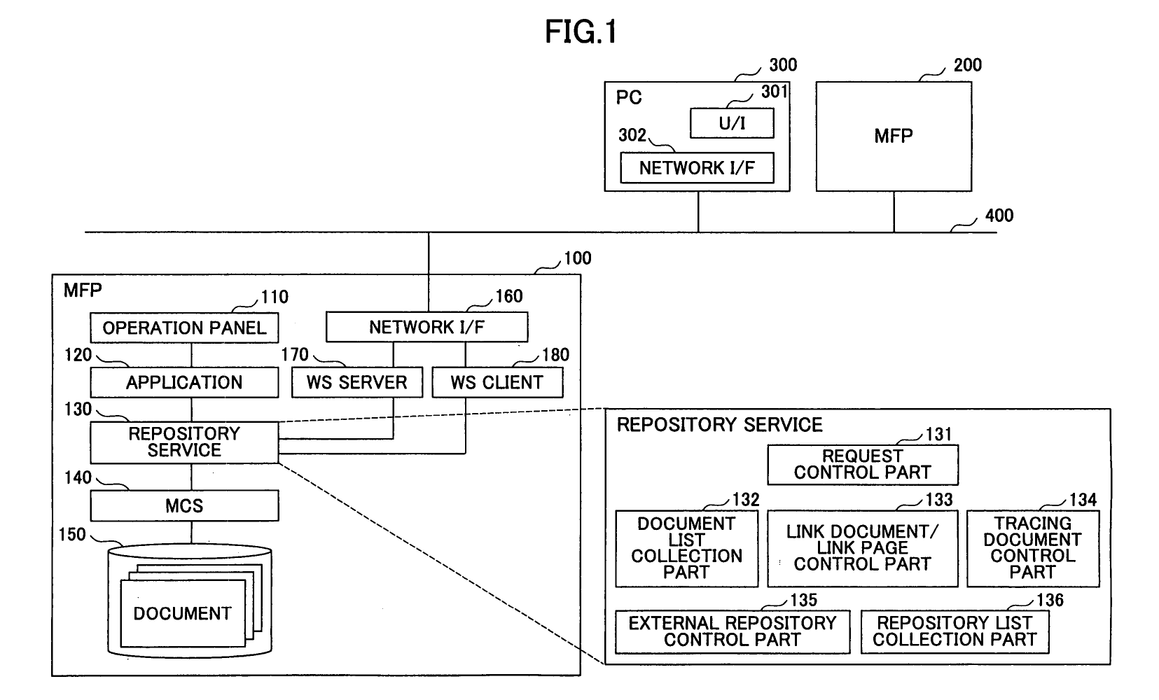

FIG. 1 is a diagram showing an example of a system configuration realizing a move history management method according to the present invention. A system shown in FIG. 1 is connected to MFPs (Multi-Function Printers) 100 and 200, and a PC (Personal Computer) 300 through a network 400 such as the Internet, a LAN (Local Area Network), or a like. It should be noted that the MFPs 100 and 200, and the PC 300 are examples of an information processing apparatus. Alternatively, the MFP 200 can be a personal computer. The MFPs 100 and 200 functions as a repository storing various types of files. A document file will be illustrated but any type of a file can be applied.

The MFP 100 includes an operation panel 110, an application 120, a repository service 130 as a file management part, an MCS (Memory Control Service) 140, a storage device 150, a network I/F 160, a WS (Web Service) server 170, and a WS client 180. The MFP 200 has the same configuration as the MFP 100. The PC 300 includes a U/I (User Interface) 301, and a network I/F 302.

The repository service 130 includes a request control part 131, a document list collection part 132, a link document/link page control part 133, a tracing document controlling part 134, an external repository control part 135, and a repository list collection part 136. Operations of the MFPs 100 and 200, and the PC 300 shown in FIG. 1 will be described later.

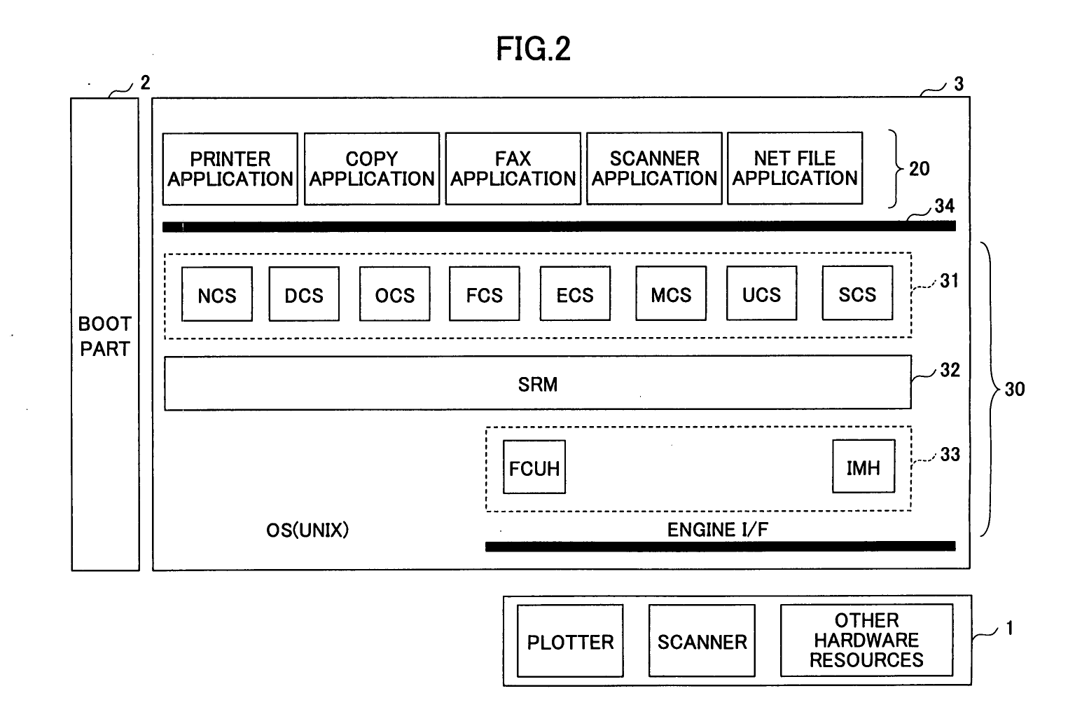

FIG. 2 is a diagram showing an example of a configuration of the MFP according to the present invention. The MFP 100 in FIG. 2 includes hardware resources 1, a boot part 2, and a software group 3. The software group 3 includes applications 20 executed on an OS (Operating System) such as UNIX, and a platform 30. The boot part 2 is conducted first when power is turned on, and activates the applications 20 and the platform 30.

The application 20 includes a printer application, a copy application, a fax application, a scanner application, and a net file application. The platform 30 includes a control service 31, an SRM (System Resource Manager) 32, and a handler layer 33.

The control service 31 includes an NCS (Network Control Service), a DCS (Delivery Control Service), an OCS (Operation Panel Control), an FCS (Fax Control Service), an ECS (Engine Control Service), an MCS (Memory Control Service), a UCS (User information Control Service), and an SCS (System Control Service). The platform 30 includes an API (Application Program Interface) 34. The handler layer 33 includes an FCUH (Fax Control Unit Handler), and an IMH (Image Memory Handler). Details of a function and an operation of each of blocks configuring the MFP in FIG. 2 are described in the Japanese Laid-open Patent Application No. 2002-84383, for example.

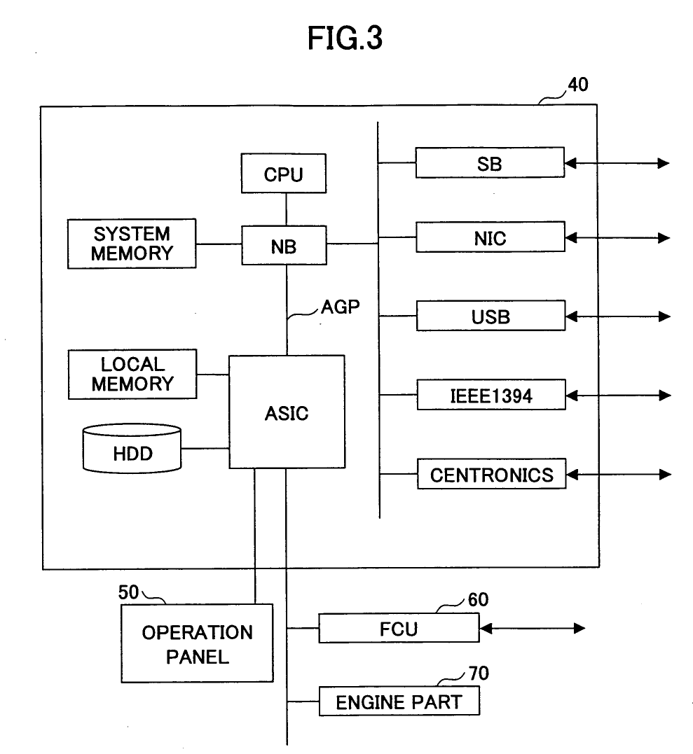

FIG. 3 is a diagram showing an example of a hardware configuration of the MFP according to the present invention. The MFP 100 includes a controller 40, an operation panel 50, an FCU 60, and an engine part 70. The controller 40 includes a CPU (Central Processing Unit), a system memory, an NB (North Bridge), an SB (South Bridge), an ASIC (Application Specific Integrated Circuit), a local memory, an HDD (Hard Disk Drive), an NIC (Network Interface Card), a USB (Universal Serial Bus) I/F, an IEEE1394 I/F, and a centronics I/F. Details of a function and an operation of each of blocks configuring the MFP in FIG. 3 is described in the Japanese Laid-open Patent Application No. 2002-84383, for example.

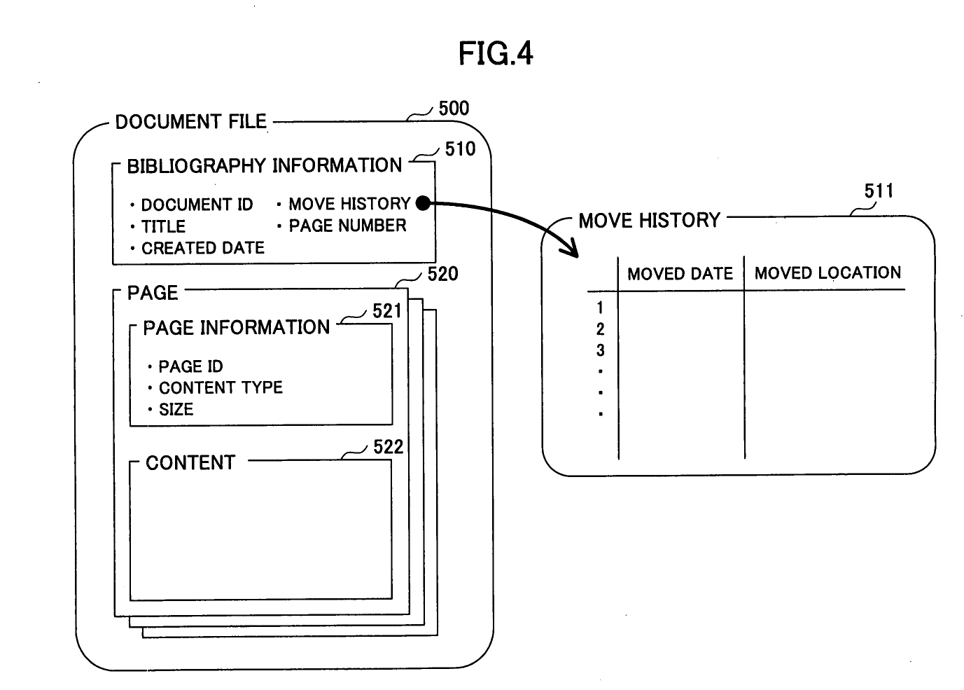

In the followings, the move history management method according to the present invention will be described in detail. In the system in FIG. 1, it is possible to move a document file between the MFP 100 and the MFP 200. For example, a user can move a document file in FIG. 4 stored in the storage device 150 such as the HDD to a storage of the MFP 200 by operating the operation panel 110 of the MFP 100. The user can remotely operate the MFPs 100 and 200 by using the PC 300.

The repository service 130 sends a request to another MFP through the network I/F 160 and the WS client 180, and also receives a request from another MFP through the network I/F 160 and the WS client 180.

The request control part 131 of the repository service 130 distributes a received request to one of the document list collection part 132, the link document/link page control part 133, the tracing document control part 134, the external repository control part 135, and the repository list collection part 136. The request control part 131 sends a response with respect to the received request to a request originator. In addition, the request control part 131 distributes a request received from the document list collection part 132, the link document/link page control part 133, the tracing document control part 134, the external repository control part 135, and the repository list collection part 136, to another MFP, and also sends a response with respect to the request to a request originator.

FIG. 4 is a diagram showing an example of a data structure of the document file according to the present invention. The document file 500 includes bibliography information 510, and page information 521 and content 522 for each page 520. The bibliography information 510 includes a document ID, a move history, a title, a page number, a page ID, and a created date as information. The page information 521 is arranged for each page 520, and includes a page ID, a content type, and a size as information. The content 522 is arranged for each page 520, and includes a content of page 520 as information.

The document ID of the bibliography information 510 is an identification of the document file 500. The move history is move history information 511 of the document file 500, and for example, includes a moved (created) date and a moved (created) location as information. The created date is a date when the document file 500 is created. The page information 521 includes a page ID, and an identification of the page 520. The content type includes a type of the content 522 as information. The size includes a size of the page 520 as information.

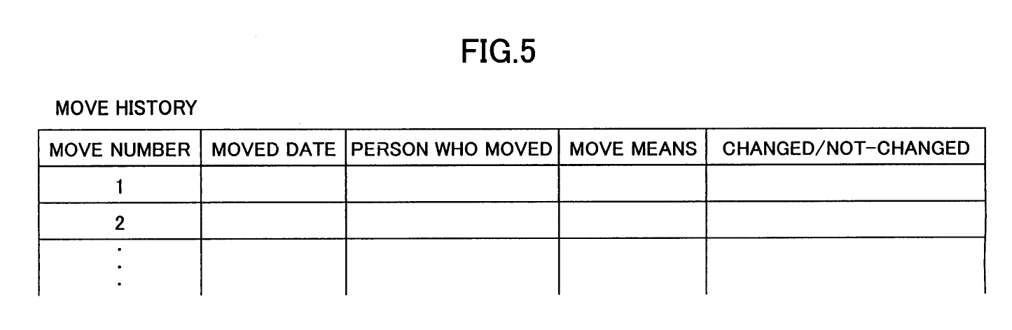

The move history may include information as shown in FIG. 5. FIG. 5 is a diagram showing a data structure of an example of the move history according to the present invention. The move history shown in FIG. 5 includes a move number showing how many times a document file was moved, a moved (created) date when the document file was moved (created), a person who moved the document file, move means which moved the document file, and changed/not-changed showing whether or not the document file was changed when the document file was moved, as information. The changed/not-changed shows whether or not the document file 500 is identical at both a move source and a move destination when the document file 500 is moved. If the document file 500 is identical at both the move source and the move destination, the changed/not-changed shows “not-changed”. If the document file 500 is not identical at the move source and the move destination, the changed/not-changed shows “change”. For example, in a case in that the document file 500 is moved after an image format of the document file 500 is converted from a tiff format into a jpeg format, the changed/not-changed is set to be “changed” with respect to this move.

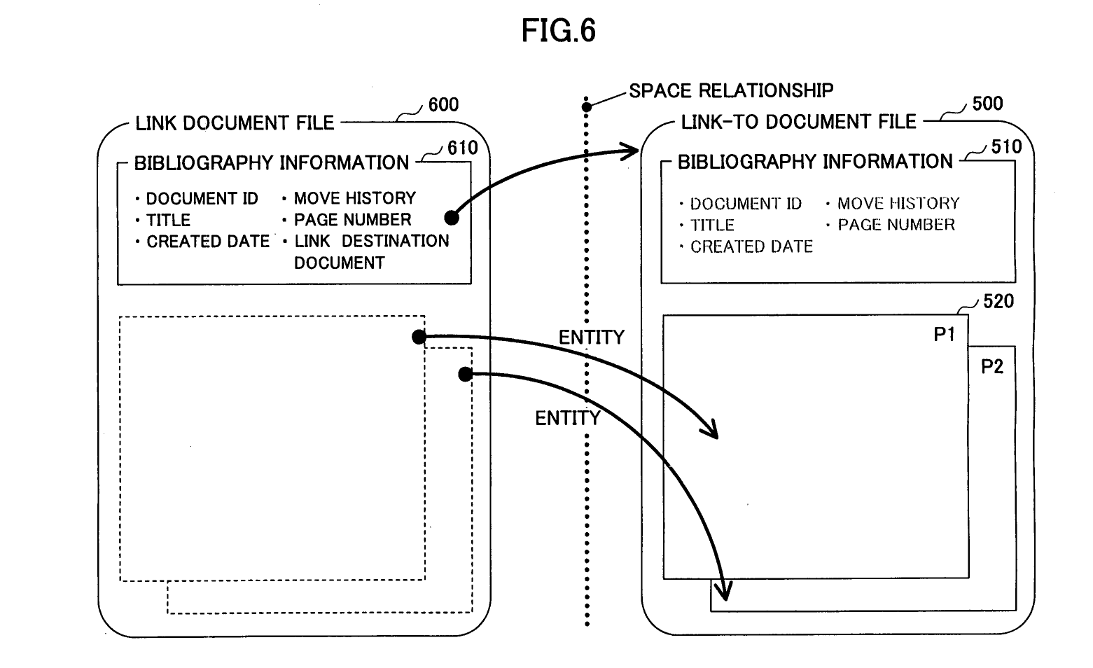

Moreover, accompanying each move of the document file 500, the link document file, a page link document file, and a tracing document file, which will be later, are created and used. The link document file is a file shown in FIG. 6 being linked to the document file 500. FIG. 6 is a diagram showing a data structure of an example of the link document file according to the present invention.

The link document file 600 includes bibliography information 610. The bibliography 610 includes a document ID, a move history, a title, a page number, a created date, and a link destination document as information.

The document ID, the move history, the title, the page number, and the created date of the bibliography information 610 are the same as the bibliography information 510 of the document file 500, and the explanation thereof will be omitted. The link destination document of the bibliography information 610 is information indicating the document file 500 of the link destination. The link destination document of the bibliography information 610 includes the bibliography information 510 of the document file 500 of the link destination, and information (for example, such as URI or a like) indicating the repository storing the document file 500 of the link destination.

For example, when a repository R links a document file DL stored therein, the link destination document of the bibliography information 610 includes a URI of the repository R, and a document ID of the document file DL in the repository R. It should be noted that since the document ID is unique only in the same repository, a URI of the repository R and the document ID of the document file DL in the repository R are included in the link destination document of the bibliography information 610, so as to distinguish between two documents having the same document ID and stored in different repositories, respectively.

The tracing document file is different from the link document file 600 in a point in that the link destination document included in the bibliography information 610 of the link document file 600 includes information in order to trace the document file 500 being moved. The link destination document included in bibliography information of the trace document file includes information indicating the move destination of the document file 500, and includes the bibliography information 510 of the document file 500 being moved and information indicating the repository to where the document file 500 is moved.

For example, in a case of tracing the document file DM being moved to the repository R, the link destination document of the bibliography information 610 includes the URI of the repository R, and the documents ID of the document file DM in the repository R.

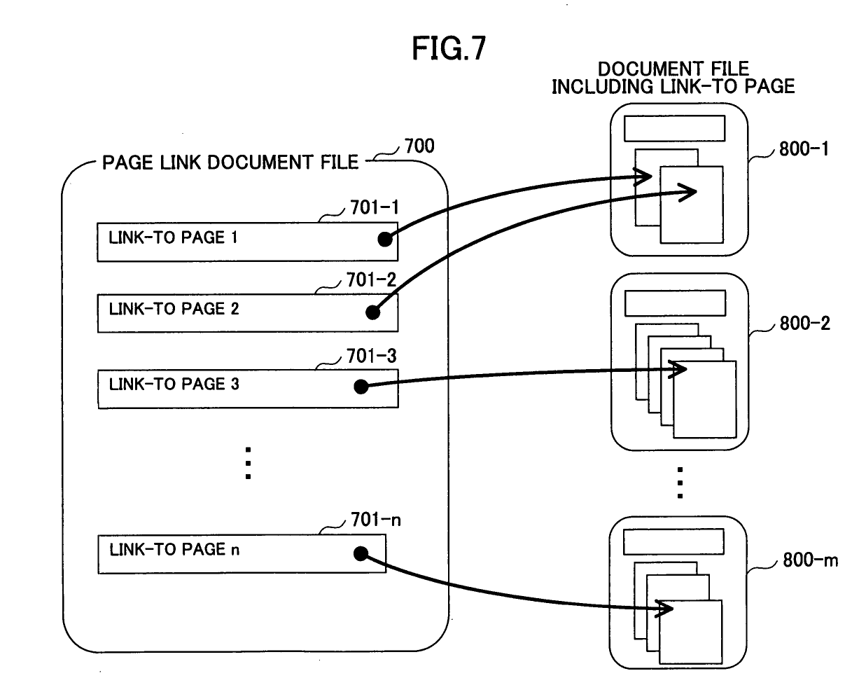

The page link document file is an aggregate of links toward pages included in one or more document files 500, and is a file as shown in FIG. 7. FIG. 7 is a diagram showing a data structure of an example of a page link document file according to the present invention.

The page link document file 700 includes links 701-1 through 701-n indicating pages included in the document files 800-1 through 800-m as a link destination. The link 701-1 through 701-n includes information indicating the repository, information indicating the document files 800-1 through 800-m, and information indicating a page of the link destination.

For example, in a case of linking a page N of a document file DPL stored in the repository R, each of the links 701-1 through 701-n includes the URI of the repository R, the document ID of the document file DPL in the repository R, and a page ID of the page N of the link destination. The link document file, the page link document file, and the tracing document file created as described above will be described in a first embodiment through a third embodiment in the following.

### FIRST EMBODIMENT

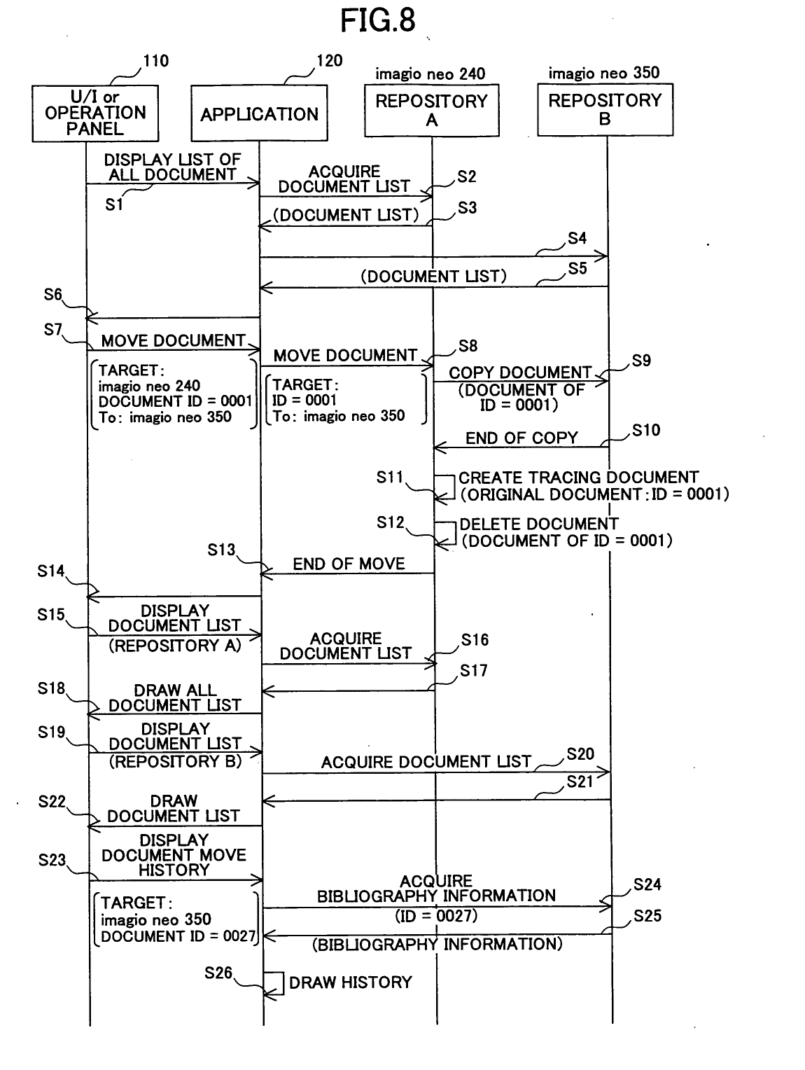

FIG. 8 is a diagram showing a sequence example for explaining a move process and a move history display process of the document file according to the first embodiment of the present invention. The user can operate any one of the operation panel 110 of the MFP 100, and the U/I 301 of the PC 300. In this embodiment, an example case in that the user operates the operation panel 110 of the MFP 100 will be described.

In step S1, the user sends an all document list display request for displaying all document files to the application 120 by operating the operation panel 110 of the MFP 100. In steps S2, S3, S4, and S5, the application 120 sends a document acquisition request for acquiring a document list to the MFP 100 as a repository A and MFP 200 as a repository B (hereinafter, simply called the repository A and the repository B), and acquires the document list. Alternatively, the application 120 may send a document list acquisition request to the repository A, so as to make the repository A acquire the document list of the repository B other than the repository A in the network 400.

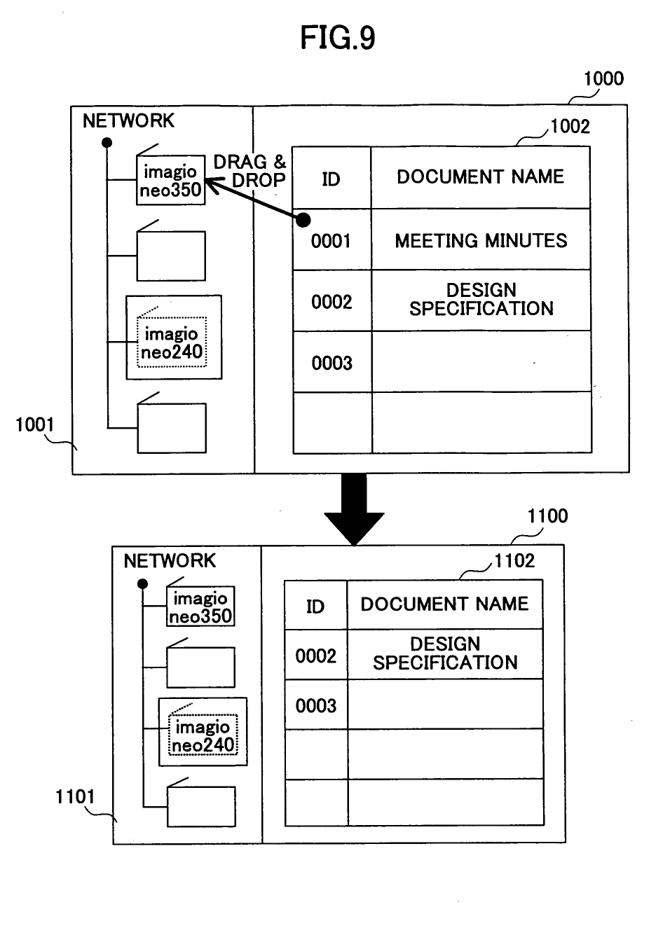

In step S6, the application 120 displays an all document list display screen 1000 at the operation panel 110 as shown in FIG. 9. FIG. 9 is a diagram showing an image example of the all document list display screen according to the first embodiment of the present invention. The all document list display screen 1000 includes a column 1001 for displaying repositories existing on the network 400 as a repository list, and a column 1002 for displaying document files stored in a repository selected from the column 1001 as a document list. In the all document list display screen 1000 shown in FIG. 9, the repository A is selected from the column 1001, and the document files stored in the repository A is displayed as the document list in the column 1002.

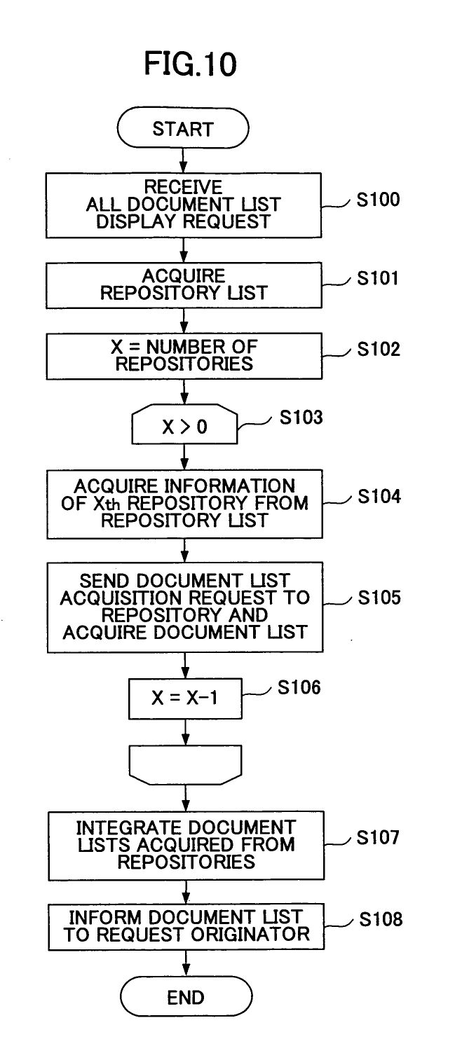

In step S1 through step S6, the application 120 conducts the all document list display process in accordance with a flowchart in FIG. 1. In step S100 in FIG. 10, the application 120 receives the all document list display request from the operation panel 110. The application 120 advances to step S101, and requests the repository list of a repository list collection part 136 of the repository 130. The repository list collection part 136 acquires information concerning repositories existing on the network 400. The information concerning the repositories existing on the network 400 may be stored beforehand at a predetermined location. The repository list collection part 136 informs the repository list to the application 120.

The application 120 advances to step S102, and acquires the number of repositories existing on the network 400 form the repository list, and substitutes the number of repositories to a variable X. The application 120 advances to step S103, and repeats processes in step S104 through S106 while the variable X is greater than “0” (zero).

The application 120 advances to step S104, and the application 120 acquires the information concerning an Xth repository from the repository list. The application 120 advances to step S105, and requests the document list of the Xth repository of the document list collection part 132 of the repository service 130. The document list collection part 132 sends the document list acquisition request to the Xth repository, and acquires the document list of the Xth repository. The document list collection part 132 informs the document list acquired from the Xth repository to the application 120.

The application 120 advances to step S106, and substitutes a value decrementing “1” from the variable X to the variable X. When the variable X is equal to or less than “0” (zero), the application 120 advances step S107, and integrates the document lists acquired from each of the repositories existing on the network 400.

The application 120 advances to step S108, and creates the all document list display screen 1000 shown in FIG. 9 from the document lists acquired from each of the repositories, and displays the all document list display screen 1000 at the operation panel 110 as a request originator.

The user can confirm the all document list display screen 1000 displayed at the operation panel 110. The user conducts a drag and drop operation moving the document file displayed at the column 1002 of the all document list display screen 1000 from one repository to another repository which are displayed at the column 1001, so that the user can move the document file among the repositories existing on the network 400.

For example, by the drag and drop operation of moving the document file “MEETING MINUTES” of the document ID “0001” displayed at the column 1002 of the all document list display screen 1000 to the repository B “imagio neo 350” displayed at the column 1001, the document file of the document ID “0001” is moved from the repository A “imagio neo 240” to the repository B “imagio neo 350”.

When the document file displayed at the column 1002 of the all document list display screen 1000 is moved to one repository displayed at the column 1001 by the drag and drop operation, the operation panel 110 conducts a process in step S7 shown in FIG. 8 and sends a document move request for moving the document file between the repositories. In the step S7 in FIG. 8, a move example, in which the document file of the document ID “0001” stored in the repository A is moved to the repository B, is shown.

In step S8, the application 120 sends the document move request for moving the document file of the document ID “0001” to the repository B, to the repository A. In step S9, the repository A sends a document copy request to the repository B to copy the document file of the document ID “0001” to the repository B. The repository B issues a new document ID “0027” to a copied document. In step S10, the repository B conducts a copy end with respect to the repository A.

In step S11, the repository A creates the tracing document file described above, and traces the document file of the document ID “0027” stored in the repository B. In step S12, the repository A deletes the document file of the document ID “0001”, which is moved to the repository B.

In step S13, the repository A informs a move end as a response to the document move request in the step SB, to the application 120. In step S14, for example, the application 120 displays a message showing an end of moving the document file for example, at the operation panel 110. In step S15, the operation panel 110 the document list display request for displaying the document files stored in the repository A to the application 120. In steps S16 and S17, the application 120 sends the document list acquisition request for acquiring the document list form the repository A, and acquires the document list. In step S18, the application 120 creates an all document list display screen 1100 shown in FIG. 9 eliminating the document file that is moved, and displays the all document list display screen 1100 at the operation panel 110.

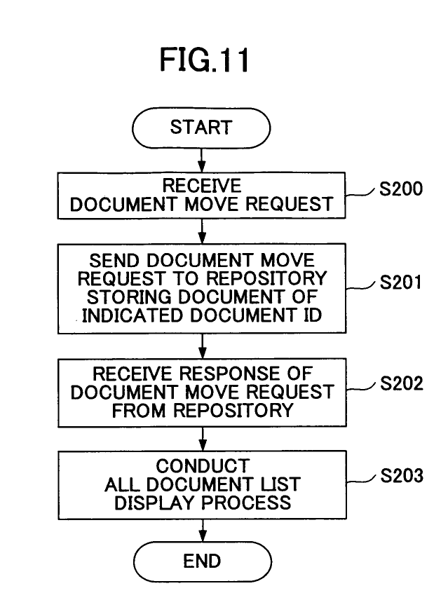

In step S7 through S18, the application 120 conducts the document move process shown in a flowchart in FIG. 11. The application 120 advances to step S200, and receives the document move request from the operation panel 110. The application 120 advances to step S201, and requests the external repository control part 135 to move the document file. The external repository control part 135 sends the document move request for moving the document file indicated by the document move request, to a repository storing the document indicated by the document move request. When the external repository control part 135 receives a response with respect to the document move request from the repository, the external repository control part 135 informs a response with respect to the document move request to the application 120.

The application 120 advances to step S202, and receives the response with respect to the document move request conducted in the step S201 from the repository. The application 120 advances to step S203, the application 120 conducts the all document list display process shown in the flowchart in FIG. 10, creates the all document list display screen 1100 in which the moved document file is eliminated, and displays the all document list display screen 1100 at the operation panel 110.

For example, when the user conducts the drag and drop operation to move the document file “MEETING MINUTES” of the document ID “0001” displayed at the column 1002 in the all document list display screen 1000 to the repository B “imagio neo 350” displayed at the column 1001, the all document list display screen 1100 is displayed at the operation panel 110. In the all document list display screen 1100, the document file of the document ID “0001” moved from the repository A to the repository B is eliminated from the column 1102.

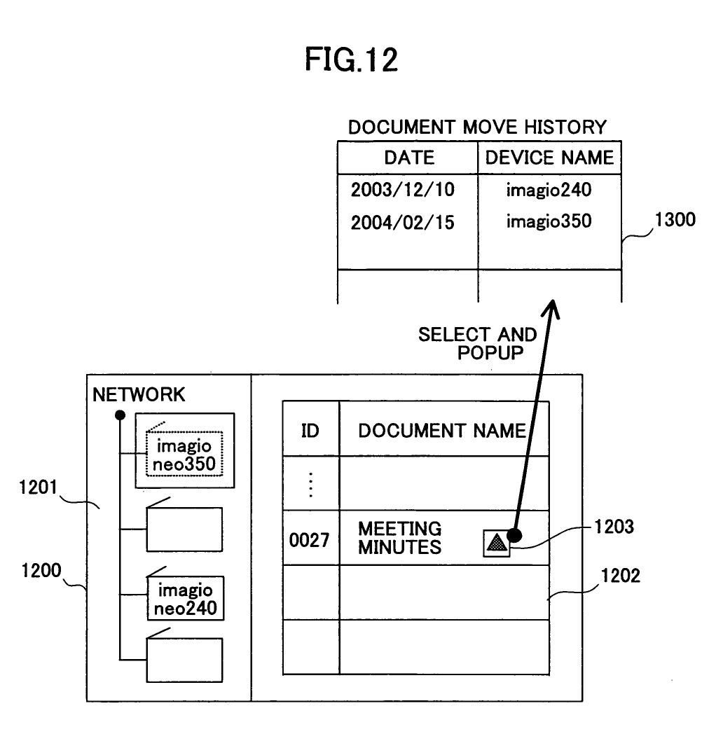

However, the user can move the document file form one repository to another repository by operating the operation panel 110. The user can display an all document list display screen 1200 as shown in FIG. 12, by selecting the repository B displayed at the column 1101 of the all document list display screen 1100. FIG. 12 is a diagram showing another image example of the all document display screen according to the first embodiment of the present invention.

For example, when the user selects the repository B “imagio neo 350” displayed at the all document list display screen 1100, the document file “MEETING MINUTES” of the document ID “0027” moved from the repository A “imagio neo 240” is displayed at a column 1202 of the all document list display screen 1200.

When the repository B being displayed at the column 1101 of the all document list display screen 1100 is selected, the operation panel 110 advances to step S19 in FIG. 8, and sends a document list display request for displaying the document files stored in the repository B. In step S20 and step S21, the application 120 sends the document list acquisition request for acquiring the document list from the repository B, to the repository A, and then acquires the document list. The application advances to step S22, creates the all document list display screen 120 shown in FIG. 12, and displays the all document list display screen 1200 at the operation panel 110.

When the user selects an icon 1203 displayed at the column 1202 of the all document list display screen 1200, a move history 1300 of the document file “MEETING MINUTES” of the document ID “0027”. The move history 1300 in FIG. 12 includes a date showing a moved (created) date, and a device name showing a location where the document was moved (created), and is created based on move history information included in the bibliography information.

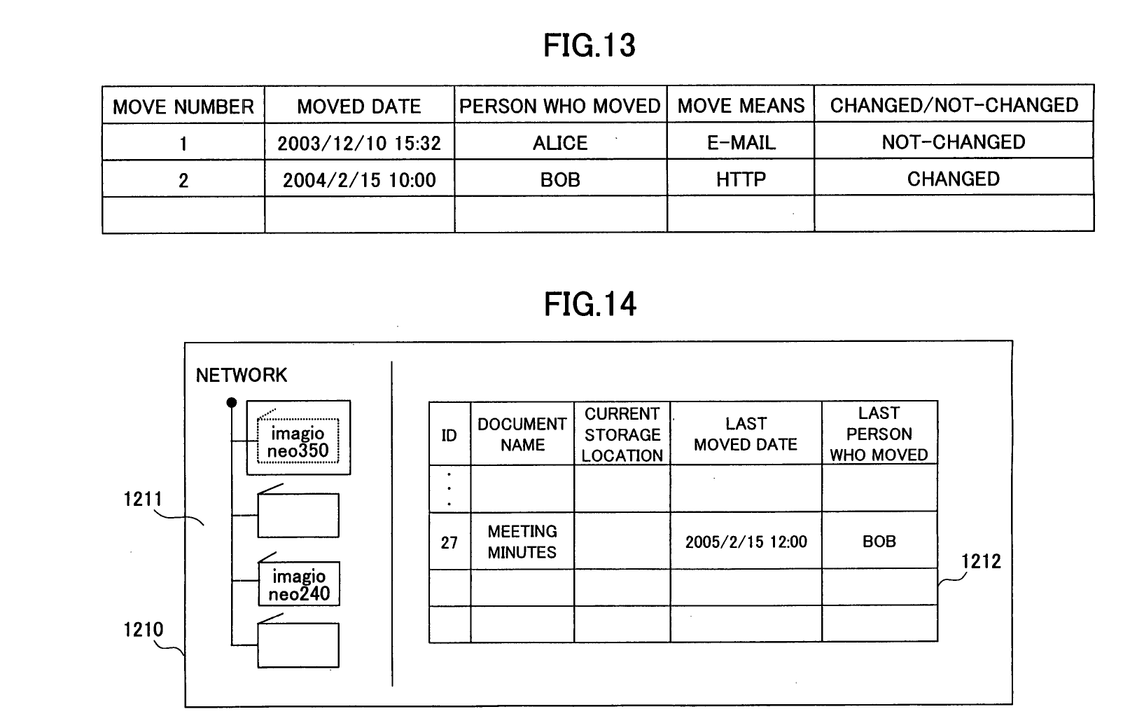

In addition, the user can display the move history of the document file “MEETING MINUTES” of the document ID “0027” at the operation panel 110 as shown in FIG. 13 by selecting the icon 1203 displayed at the column 1202 of the all document list display screen 1200. FIG. 13 is a diagram showing an image example of the move history according to the first embodiment of the present invention. The move history in FIG. 13 includes a move number, a moved (created) date, a person who moved the document file, move means, and changed/not-changed as information. The move history in FIG. 13 is created based on the move history information including the bibliography information.

In addition, the user can display an all document list display screen 1210 as shown in FIG. 14 by selecting the repository B displayed at the column 1101 of the all document list display screen 1100. FIG. 14 is a diagram showing another image example of the all document list display screen according to the first embodiment of the present invention.

At the column 1211 of the all document list display screen 1210 in FIG. 14, as the move history concerning a move of the document file conducted last, a current storage location, a last moved date, and a last person who moved the document file. The move history concerning the latest move of the document is shown in a row of the latest moved date in the move history information of the document file.

Since a row showing the latest moved date in the move history information of the document file is added to the last row in the move history information each time the document file is moved, the current storage location is the same as the last move destination of the document file.

When the icon 1203 displayed at the column 1202 of the all document list display screen 1200 is selected, the operation panel 110 advances to step S23 in FIG. 8, and sends the document move history display request for displaying the move history 1300 to the application 120. In step S23 in FIG. 8, an example of a display for the move history 1300 of the document file of the document ID “0027” stored in the repository B is shown.

In steps S24 and S25, the application 120 sends a bibliography information acquisition request for acquiring the bibliography information of the document file of the document ID “0027” to the repository B, and acquires the bibliography information of the document file of the document ID “0027”. Then, the application 20 advances to step S26, creates the move history 1300 shown in FIG. 12, and displays the move history 1300 at the operation panel 110.

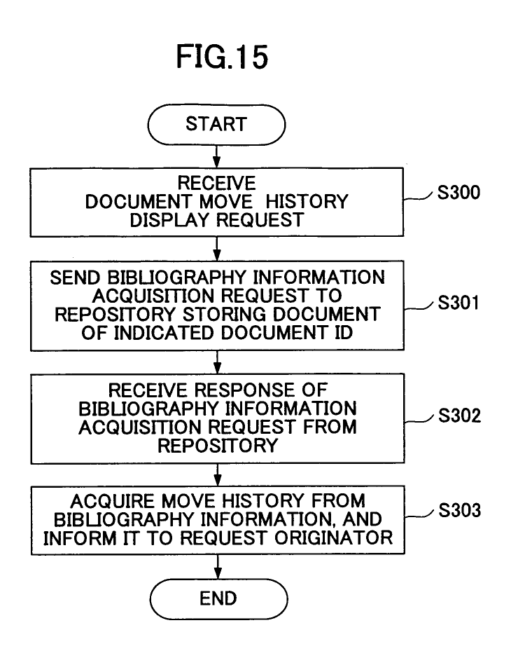

In steps S23 through S26, the application 120 conducts a document move history display process shown in a flowchart in FIG. 15. The application 120 advances to step S300, and receives the document move history display request from the operation panel 110. The application 120 advances to step S301, and requests the external repository control part 135 of the repository 130 to acquire the bibliography information of the document file indicated by the document move history display request. The external repository control part 135 sends the bibliography information acquisition request for acquiring the bibliography information of the document file indicated by the document move history display request with respect to the repository storing the document file indicated by the document move history display request. The external repository control part 135 acquires the bibliography information of the document file indicated by the document move history display request, and informs the bibliography information to the application 120.

The application advances to step S302, and receives the bibliography information of the document file indicated by the document move history display request as a response with respect to the bibliography information acquisition request conducted in the step S301. The application advances to step S303, creates the move history 1300 as shown in FIG. 12, and displays the move history 1300 at the operation panel 110. Accordingly, the user can confirm the move history of the document file by operation the operation panel 110.

### SECOND EMBODIMENT

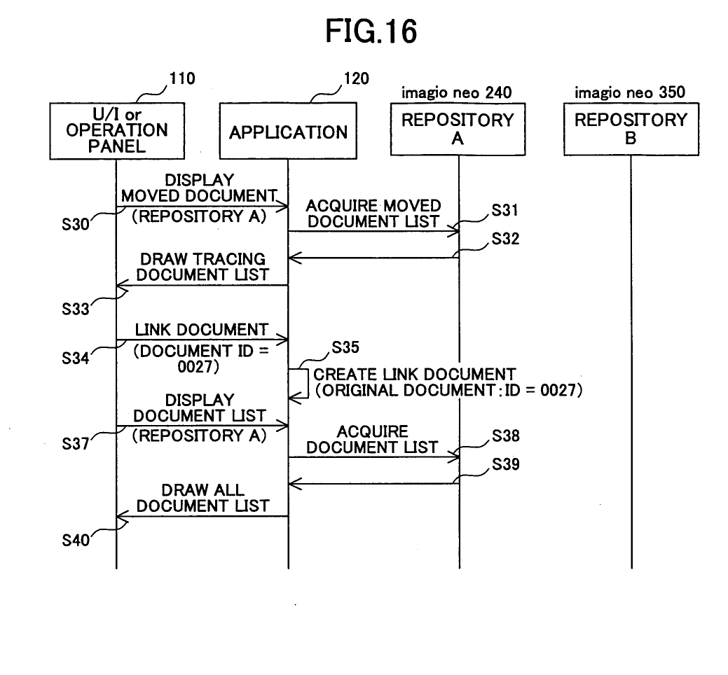

FIG. 16 is a diagram showing a sequence example for explaining a trace process and a like process for the document file which is moved, according to a second embodiment of the present invention. The sequence in FIG. 16 shows an example conducted after the sequence shown in FIG. 8.

In step S30 following to the step S26 in FIG. 8, the user sends a display request of a moved document file, which has been moved, for displaying the moved document file to the application 120. In step S31 and step S32, the application 120 sends a moved document list acquisition request to the repository A in order to acquire a moved document list from the repository A, and then acquires the moved document list. The moved document list is created by using the above-described tracing document file.

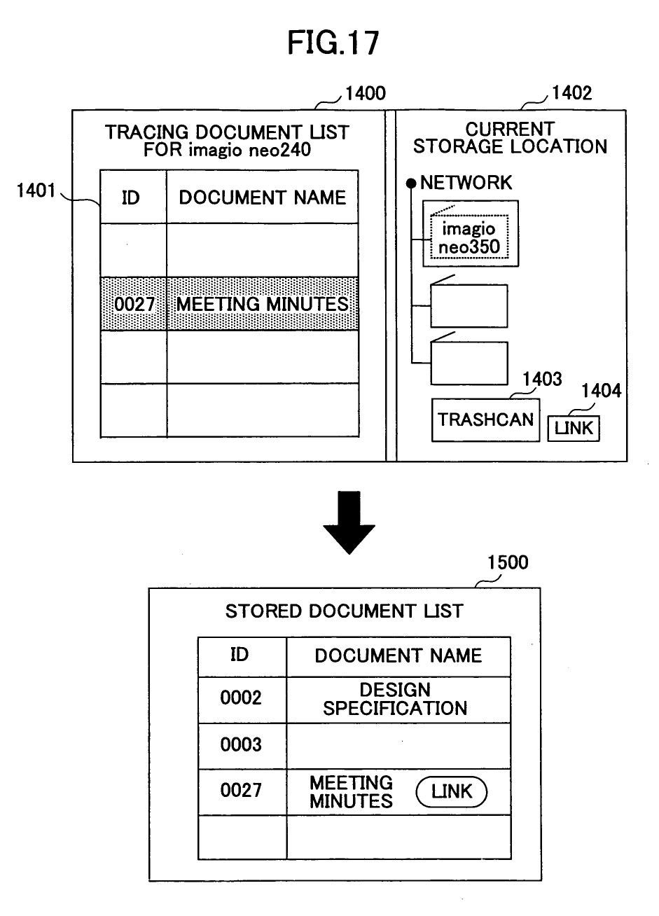

The application 120 advances to step S33, and displays a moved document list display screen 1400 as shown in FIG. 17 at the operation panel 110. FIG. 17 is a diagram showing an image example of the moved document list display screen according to the second embodiment of the present invention. The moved document list display screen 1400 includes a column 1401 for displaying the moved document files, which are moved from the repository A “imagio neo 240”, as the tracing document list, and a column 1402 for displaying the repository currently storing the moved document file selected from the column 1401 as a current storage.

In the moved document list display screen 1400 in FIG. 17, the document file “MEETING MINUTES” of the document ID “0027” displayed at the column 1401 as the moved document file is selected, and the repository B “imagio neo 350” currently storing the document file “MEETING MINUTES” of the document ID “0027” is displayed as the current storage location.

In the document list display screen 1400 in FIG. 17, the repository currently storing the move document file selected by the user is displayed visually different from other repositories. In a case in that the moved document file selected from the column 1401 is not stored in any repository on the network 400 or in a case in that the moved document file is deleted, an icon 1403 such as a trashcan or a like is emphatically displayed.

In steps S30, S31, S32, and S33, the application 120 conducts the moved document display process shown in a flowchart in FIG. 18. The application 120 advances to step S400, and receives the moved document display request from the operation panel 110. The application 120 advances to step S401, and requests the moved document list to the tracing document control part 134 of the repository service 130. The tracing document control 134 sends the moved document list acquisition request to the repository indicated by the moved document display request, and then acquires the moved document list. The tracing document control part 134 informs the moved document list acquired from the repository to the application 120.

The application 120 advances to step S402, the application 120 receives the moved document list as a response with respect to the moved document list acquisition request conducted in the step S401. The application 120 advances to step S403, and displays the moved document list display screen 1400 shown in FIG. 17 at the operation panel 110.

However, the user can trace the document file moved from one repository to another repository by operation the operation panel 110. By selecting the moved document file from the column 1401 of the moved document list display screen 1400, and clicking an icon 1404 showing “Link” in the column 1402, the user can create a link document file that is to link to the moved document file. In this case, only a link toward the moved document file is targeted. It should be noted that it is not limited to the link toward the moved document file but all document files stored in the repositories existing on the network 400 can be tagged to be linked.

When the moved document file is selected from the column 1401 of the moved document list display screen 1400 and also the icon 1404 showing “Link” of the column 1402 is clicked, the operation panel 110 advances to step S34 in FIG. 16, and sends a document link request for linking to the moved document file, to the application 120. In step S35, the application 120 creates the link document file linking to the moved document file selected from the column 1401.

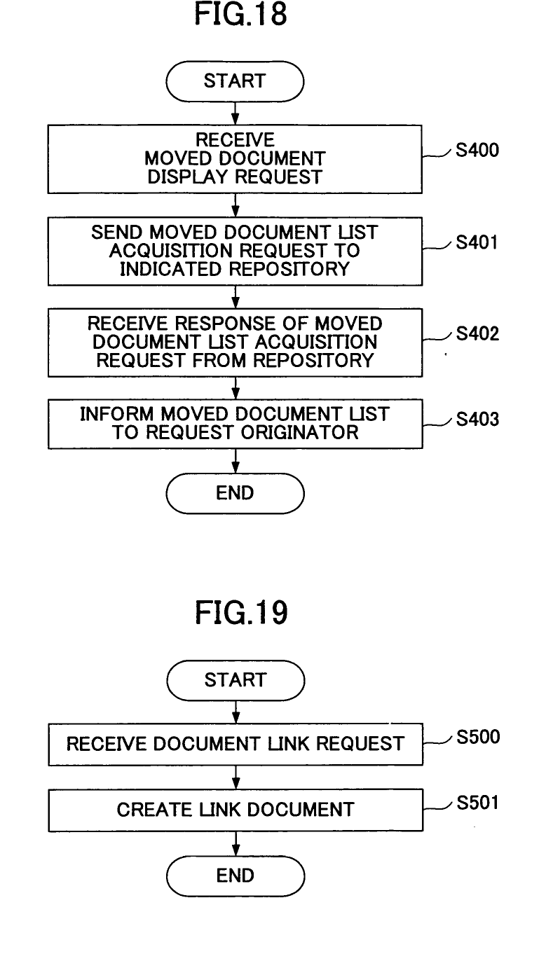

In steps S34 and S35, the application 120 conducts a document link process shown in FIG. 19. The application 120 advances to step S500, and receives the document link request operation panel 110. Next, the application 120 advances to step S501, and creates the link document file for linking toward the moved document file selected from the column 1401. For example, when the moved document file “MEETING MINUTES” is selected from the column 1401 of the document list display screen 1400, and the icon 1404 showing “Link” of the column 1402 is clicked, the link document file linking toward the document file “MEETING MINUTES” stored in the repository B is created.

In step S37 in FIG. 16, the operation panel 110 sends the document list display request for displaying the document file stored in the repository A, to the application 120. In steps S38 and S39, the application 120 requests a document list of the repository A to the document list collection part 132 of the repository service 130. The document list collection part 132 sends the document list acquisition request to the repository A, and acquires the document list of the repository A. The document list collection part 132 informs the document list acquired from the repository A, to the application 120.

The application 120 advances to step S40, creates an all document list display screen 1500 as shown in FIG. 17 for showing a moved document file list, and displays the all document list display screen 1500 at the operation panel 110.

The all document list display screen 1500 in FIG. 17 displays the link document file for linking toward the document file “MEETING MINUTES” stored in the repository B in addition to the document files stored in the repository A. When the document file being a link target is moved, the link document file is automatically updated. Accordingly, the user can easily link the document file moved from one repository to another repository by simply operating the operation panel 110.

### THIRD EMBODIMENT

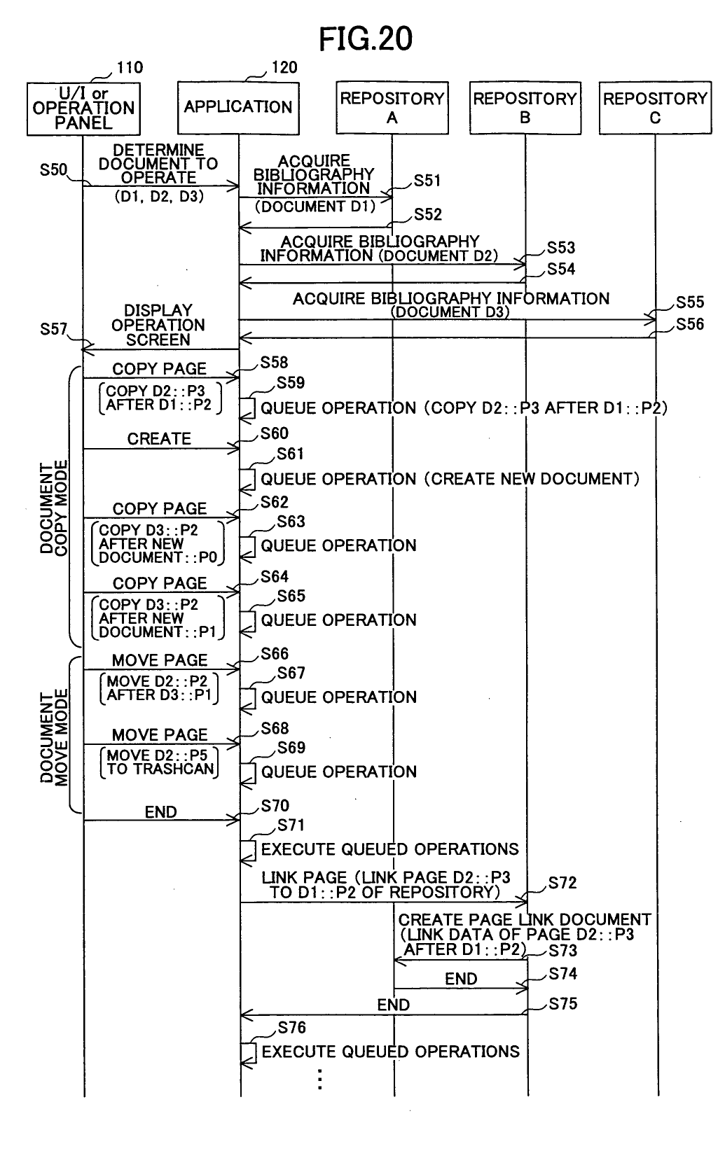

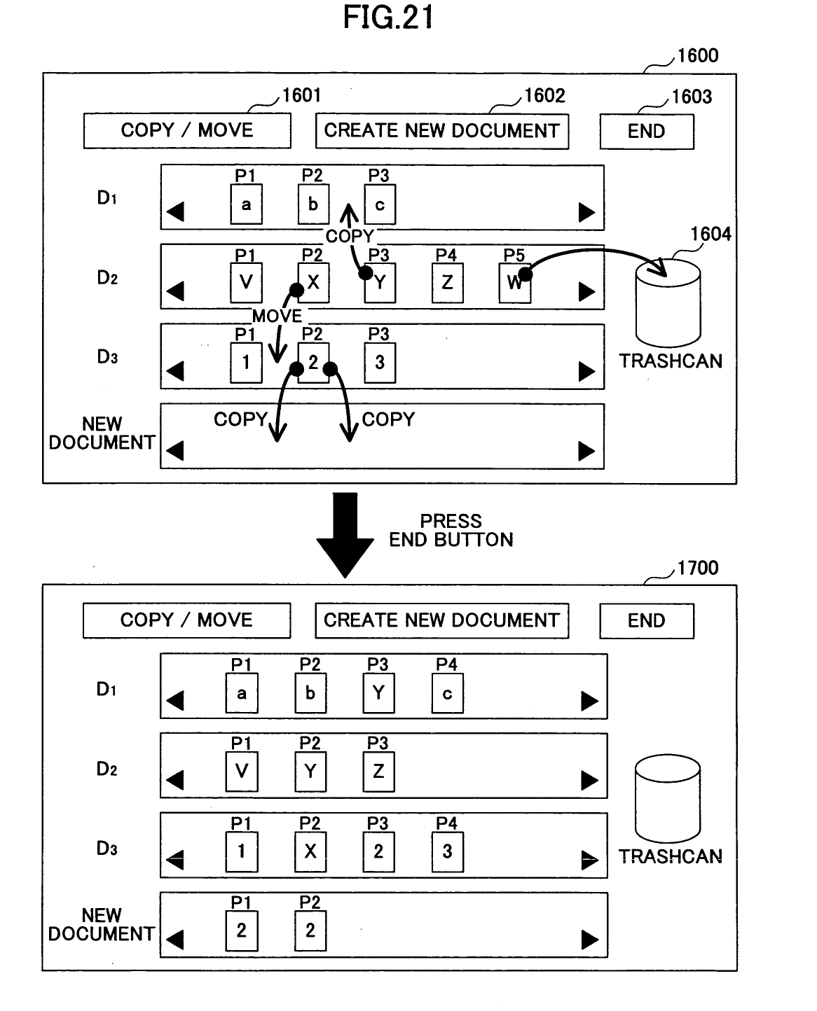

FIG. 20 is a diagram showing a sequence example of a process for operating the document file by a page unit, according to a third embodiment of the present invention. In step S50, the user determines the document of an operation target by using the all document list display screen 1000 as shown in FIG. 9 displayed at the operation panel 110. In the sequence in FIG. 20, an example, in which document files D1, D2, and D3 stored in repositories A, B, and C are determined as the documents files being the operation targets, is shown.

In steps S51, S52, S53, S54, S55, and S56, the application 120 acquires the bibliography information of the documents D1, D2, and D3 stored in the repositories A, B, and C as described above. The application 120 advances to step S57, and displays a document file operation screen 1600 as shown in FIG. 21 at the operation panel 110. FIG. 21 is a diagram showing an image example of the document file operation screen according to the third embodiment of the present invention.

The document file operation screen 1600 includes a button 1601 for switching between a document copy mode and a document move mode, a button 1602 for creating a new document file as a new document, a button 1603 showing “END” and for ending an operation with respect to the document files D1, D2, and D3, and an icon 1604 showing “TRASHCAN”, as well as pages “a”, “b”, and “c”, pages “V”, “X”, “Y”, “Z”, and “W”, and pages “1”, “2”, and “3” included in the document files “D1”, “D2”, and “D3” being the operation targets are displayed.

The user switches between the document copy mode and the document move mode, creates a new document, and operates the pages “a”, “b”, and “c”, the pages “V”, “X”, “Y”, “Z”, and “W”, and the pages “1”, “2”, and “3” included in the document files D1, D2, and D3, by operating the operation panel 110.

In step S58 through step S76, an example of an operation with respect to the document files D1, D2, and D3 is shown. In step S58 through step S65, a process conducted in a case of the document copy mode is shown. In addition, in step S66 through step S76, a process conducted in a case of the document move mode is shown.

In step S58, the user operates the operation panel 110 so that the page “Y” of the document file D2 is copied after the page “b” of the document file D1. In step S59, the application 120 queues a content of the operation conducted in step S58 informed from the operation panel 110.

In step S60, the user clicks a button 1602 of the document file operation screen 1600, so that a new document is displayed in addition to the document files D1, D2, and D3. In step S61, the application 120 queues a content of the operation conducted in step S60 informed from the operation panel 110.

In step S62, S63, S64, and S65, the user operates the operation panel 110, so that two volumes of the page “2” of the document file D3 are copied to the new document. The application 120 queues a content of the operation conducted in step S62, and S64 informed from the operation panel 110.

In step S66, the user moves the page “X” of the document file D2 after the page “1” of the document file D3 by operating the operation panel 110. The process advances to step S67, and the application 120 queues a content of the operation conducted in step S66 informed from the operation panel 110.

In step S68, the user moves the page “W” of the document file D2 to an icon 1604 showing “TRASHCAN” by operating the operation panel 110. The process advances to step S69, and the application 120 queues a content of the operation conducted in step S68 informed from the operation panel 110. At this stage, the application 120 displays a document file operation screen 1700 as shown in FIG. 21 at the operation panel 110.

When the user clicks the button 1603 showing “END”, the process advances to step S70, and the operation panel 110 informs an operation end to the application 120. When the operation end is informed, the process advances to step S71, and the application 120 consecutively conducts the contents of operations being queued.

In step S72, the application 230 sends a page link request for copying the page “Y” of the document file D2 after the page “b” of the document file D1, to the repository B by using the link document/link page control part 133. The process advances to step S73, and the repository B requests the repository A to create a page link document file as described above to link the page “Y” of the document file D2. The process advances to step S74, and the repository A informs an end of creating the page link document file to the repository B after the repository A creates the page link document file to link the page “Y” of the document file D2. The process advances to step S76, and the application 230 conducts a next content of the operation being queued. It should be noted that each of repositories A, B, and C may be conducted at another timing for each page.

However, the user can conduct an operation of copying or moving the document file from one repository to another repository, or deleting the document file every one page by operation the operation panel 110.

According to the present invention, it is possible to provide the information processing apparatus, the move history management method, and a data structure of the image data for easily managing the move history of the image data.

The present invention is not limited to the specifically disclosed embodiments, and variations and modifications may be made without departing from the scope of the present invention. In the above embodiments, the document file is one example of image data. The image data may be a file handled in a file system, as well as data read by scanner, print data, or a like. In the above embodiments, the repository is one example of an image data storing part.

Various types of storages including a storage unit, a memory, and a like can be used as an image data storing part. In the above embodiments, the application 120 is one example of the display control part. In the above embodiments, the operation panel 110 and the U/I 301 are examples of a display unit.

The present application is based on the Japanese Priority Applications No. 2004-185230 filed on Jun. 23, 2004 and No. 2005-174361 filed on Jun. 14, 2005, the entire contents of which are hereby incorporated by reference.

1. An information processing apparatus for managing move history information of image data being stored in an image data storing part, said information processing apparatus comprising:
an image data managing part acquiring the move history information of the image data stored in the image data storing part from the image data, and providing the move history information as data for displaying the move history information.

2. The information processing apparatus as claimed in claim 1, wherein the image data managing part acquires a moved date when the image data are moved and information showing a move source and a move destination of the image data from the image data as the move history information of the image data.

3. The information processing apparatus as claimed in claim 1, wherein the image data managing part a move count how many times the image data were moved, a moved date when the image data were moved, move means which moved the image data, and information showing whether or not the image data were changed, form the image data as the move history information of the image data.

4. The information processing apparatus as claimed in claim 1, wherein the image data managing part acquires first information of the image data storing part, and second information of the image data stored in the image data storing part, and provides the first information and the second information as a part of data for displaying the move history information.

5. The information processing apparatus as claimed in claim 4, further comprising a display control part receiving data for displaying the move history information and displaying the move history information at a predetermined display unit.

6. The information processing apparatus as claimed in claim 5, wherein the display control part displays information of the image data storing part and information of the image data stored in the image data storing part in addition to the move history information at the display unit.

7. The information processing apparatus as claimed in claim 5, wherein the display control part displays information concerning a move conducted last in the move history information.

8. The information processing apparatus as claimed in claim 1, wherein the image data storing part is a repository.

9. An information processing apparatus for managing move history information of image data previously stored in an image data storing part, said information processing apparatus comprising:
an image data managing part acquiring move history information of the image data from link data including the move destination information of the image data and the move history information of the image data, and providing the move history information of the image data as data for displaying the move history information.

10. The information processing apparatus as claimed in claim 9, wherein the image data managing part updates the move history information of the link data when the image data are further moved to another image data storing part.

11. The information processing apparatus as claimed in claim 9, wherein the image data managing part creates tracing data including the move destination information of the image data to the image data storing part in which the image data were previously stored when the image data are further moved to another image data storing part.

12. The information processing apparatus as claimed in claim 9, wherein the image data managing part acquires first information of the image data storing part and second information of the image data stored in the image data storing part, and provides the first information and the second information as a part of data for displaying the move history information.

13. The information processing apparatus as claimed in claim 12, further comprising a display control part receiving data for displaying the move history information and displaying the move history information at a predetermine display unit.

14. The information processing apparatus as claimed in claim 13, wherein the display control part displays information of the image data storing part and information of the image data stored in the image data storing part in addition to the move history information at the display unit.

15. The information processing apparatus as claimed in claim 14, wherein the display control part displays another image data storing part currently storing the image data at the display unit.

16. The information processing apparatus as claimed in claim 14, wherein the display control part displays information showing that the image data previously stored in the image data storing part are deleted, at the display unit.

17. The information processing apparatus as claimed in claim 9, wherein the display control part displays the link data with the image data currently stored in the image data storing part at the display unit.

18. The information processing apparatus as claimed in claim 9, wherein a move destination of the image data is set for each page in the link data.

19. The information processing apparatus as claimed in claim 9, wherein the data storing part is a repository.

20. A move history management method conducted in an information processing apparatus for managing move history information of image data being stored in an image data storing part, said move history management method comprising the step of:
acquiring move history information of the image data being stored in the image data storing part from the image data, and providing the move history information as data for displaying the move history information.

21. A move history management method conducted in an information processing apparatus for managing move history information of image data previously stored in an image data storing part, said move history management method comprising the step of:
acquiring move history information of the image data form link data including the image data and the move history information of the image data, and providing the move history information as data for displaying the move history information.

22. A data structure of image data including bibliography information and page information,
wherein move history information of the image data is recorded in the bibliography information, and the move history information is read out from the bibliography information by an information processing apparatus for managing the move history information of the image data being stored in the image storing part, so that the image history information is provided as data for displaying the move history information of the image data.
